(19) United States
(12) Patent Application Publication
(10) Pub. No.: US 2014/0074773 A1
(43) Pub. Date: Mar. 13, 2014

(54) SYSTEM AND METHOD FOR ASSET INTEREST DETERMINATION

(71) Applicant: Madison Logic, Inc., New York, NY (US)

(72) Inventors: Eric Matlick, Mantauk, NY (US); Oleg Khavronin, Oakland, NJ (US); Vincent Henri Lucien Turk, New York, NY (US); Eugene Livchits, Brooklyn, NY (US)

(73) Assignee: Madison Logic, Inc., New York, NY (US)

(21) Appl. No.: 14/023,089

(22) Filed: Sep. 10, 2013

Related U.S. Application Data
(60) Provisional application No. 61/699,167, filed on Sep. 10, 2012.

(51) Int. Cl. G06F 17/30

(52) U.S. Cl. CPC G06F 17/30011
USPC 707/608

(57) ABSTRACT

A system for generating applicable electronically transmissible documents includes an applicability service that determines electronically transmissible documents from an electronically transmissible document reference library that are most likely to result in revenues when provided to the user of a website. The applicability service may determine the applicable electronically transmissible documents based upon a number of specifications provided by a website publisher, the electronically transmissible document provider, an electronically transmissible document owner, and/or the user accessing the website.

### CROSS REFERENCE TO RELATED APPLICATION

This application claims the benefit of U.S. Provisional Patent Application No. 61/699,167, entitled “System and Method For Asset Interest Determination”, filed on Sep. 10, 2012, which is hereby incorporated by reference in its entirety.

### BACKGROUND

The current application relates generally to web-based asset provision and more particularly, to systems and methods for generating a customized list of one or more electronically transmissible documents applicable to a user.

Vendors of particular products and/or services may entice users to purchase products based upon advertisements and/or information centered around the use of their products. As used herein, the term “assets” may refer to items centered around a particular subject matter, such as electronically transmissible documents pertaining to a particular product or subject matter. For example, typical assets may include technical and/or marketing documentation in the form of white papers, technical papers and documents, technical videos, webinars, and/or audio files describing particular features, use cases, or other topics of interest pertaining to vendor's products and/or services. In some cases, vendors provide these assets as a tool to focus a user's attention on the vendor's product or a particular field of the vendor. Generally speaking, such documentation may be provided to web users via a publisher's web page accessed by the web users. In certain scenarios, a vendor may offer the assets of one or more publishers or other providers, and their business model allows for realization of revenue based upon certain user activities with respect to the offered assets.

Asset providers may typically receive revenues from the vendors based upon web users clicking through to a download and/or accessing the assets provided by the vendor. Unfortunately, often times, the asset providers offer assets that are not interesting and/or applicable to the web users. Accordingly, because the web users may be uninterested in the offered assets, there may be missed opportunities for revenue generation because the web users may not download or access the offered assets. Further, in some cases, the asset providers may offer assets that, while interesting to the web users, do not generate revenues or that generate reduced revenues for the asset provider. Accordingly, there is a need for an improved system and method to address the aforementioned issues. In general, a goal of such systems is to provide users with the most relevant and interesting materials for their consideration and use, while allowing vendors and the original asset providers with revenue by virtue of user interest and consumption.

### BRIEF DESCRIPTION

In accordance with an embodiment of the invention, a method for determining a list of revenue-generating assets relating to a user is provided. The method includes gathering identifying information relating to the user, wherein the user is accessing a website and that access results in requesting the list of revenue-generating assets; gathering potential assets from a list of available assets; and determining the list of revenue-generating assets from the potential assets based upon at least the identifying information relating to the user.

In accordance with another embodiment of the invention, a non-transitory, computer-readable medium, comprising computer-readable instructions is provided. The computer-readable instructions accept a web-request initiated from a user visiting a website, the web-request configured to provide identifying information of a user of the website and request a number of assets that are applicable to the user; and generate a list of assets that is applicable to the user based upon the identifying information; wherein the list of assets comprises a number of assets equal to the requested number of assets when enough assets are available, and wherein the assets provided in the list of assets comprise assets that are most likely to produce revenue for an asset provider suggesting the assets.

In accordance with another embodiment of the invention, a system includes an asset provider server hosting an asset applicability service. The asset applicability service receives web requests initiated from a user visiting a website hosted by a publisher's web server, the web request including a number of applicable assets for a user of the website and identifying information for a user of the website. Further, the service compiles an asset reference library comprising a listing of available assets provided by one or more vendors via a vendor server or storage device and predicts a subset of assets that are likely to result in the highest revenues for the asset provider. The subset of assets is provided to the user of the website via an asset response comprising the subset of assets. The applicability server determines the subset of assets based at least upon: the number of applicable assets in the web request, a set of rules or specifications provided by the one or more vendor servers, and a set of applicability rules relating to anticipated yields of each of the assets in the asset reference library based upon the user's identifying information.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a web-based system that generates revenue for an asset provider by providing assets to a web host for consumption by a web user;

FIG. 2 is a block diagram of an applicability service providing the applicable assets from a plurality of vendors to a user of the web host;

FIG. 3 is a block diagram of the applicability service of FIG. 2 making use of historical information to determine applicable assets for a user;

FIG. 4 is a flow chart depicting a process for selecting applicable assets for a given user; and

FIG. 5 is flow chart depicting a process for selecting and sorting applicable assets.

### DETAILED DESCRIPTION

As discussed in detail below, embodiments of the present invention provide a system and method of providing applicable assets to a web user. The assets may include any digital content, such as white papers, technical papers and documents, audio files, video files, web pages, etc., that may be referenced via a transmission to the web user. The system for determining the applicable assets includes an asset provision computer designed to determine assets, out of a library of assets, that will be most likely to be of interest to users, and therefore to generate revenues for an asset provider that provides the asset or a web host requesting the asset.

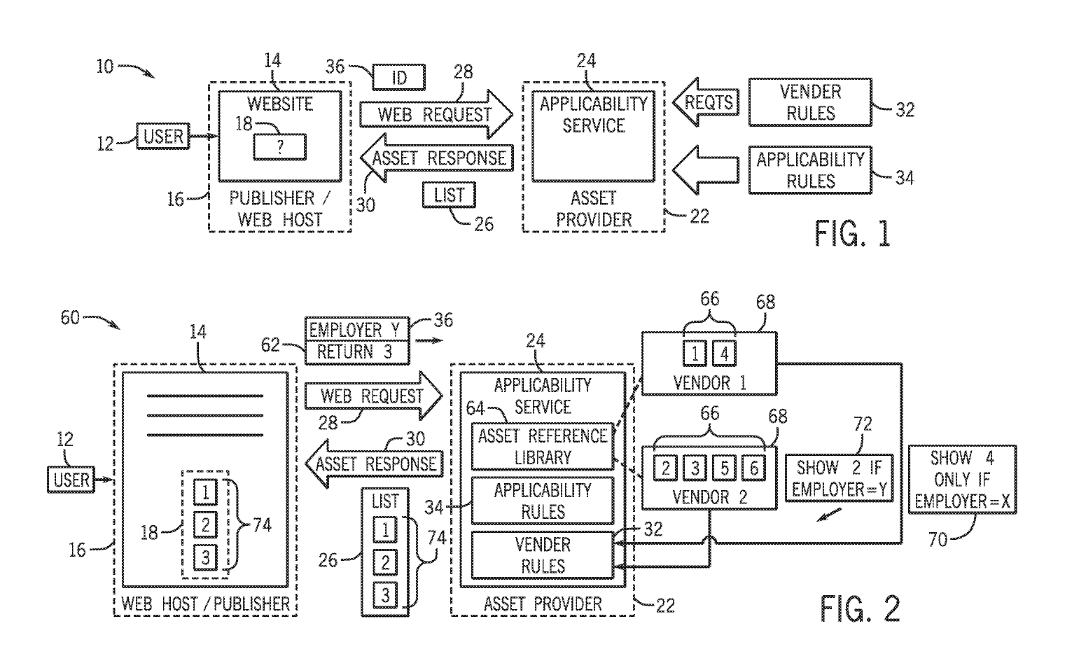

FIG. 1 is a block diagram of a system 10 using the enhanced applicable asset provider. The system 10 serves a user 12 who accesses a website 14 published by a publisher or web host 16. The web host 16 may include an advertisement or asset listing space 18 designed to display an asset or assets (e.g., assets in the list 26, such as assets 74 of FIG. 2) suggested by an asset provider 22. For example, the asset provider 22 may provide an asset applicability service 24 on a server or other computer system that suggests content by, for example, providing a list 26 of links or other identifiers of digital content provided by a host of the digital content, such that the digital content may be accessed through the website 14 at a hosting location (e.g., a storage server) provided by the digital content host. To invoke the applicability service 24, the website 14 may submit a web or service request 28 to the applicability service 24. The applicability service 24 may respond with an asset response 30 that provides a list 26 of one or more applicable assets. Further, the applicability service 24 may determine the most applicable assets based upon rules 32 or other data provided by an asset owner. Further, other applicability rules 34 may be supplied to the applicability service 24. The rules 32 and 34 may be used to select and/or sort applicable assets from a collection of assets known by the applicability service 24.

As will be discussed in more detail below, the asset provider 22 may obtain information about the user 12 via identifying information 36 provided in the web request 28. For example, the identifying information 36 may be a Media Access Control address (MAC address), an Internet Protocol (IP) address, or other information that identifies the user 12 (or a computer system of user 12). The identifying information 36 may also include characteristic information for the user 12, such as employment information (e.g., employer identification information, job title, job description, field of expertise, etc.) and/or other traits (e.g., whether the user 12 is male or female, the age of user 12, marital status, etc.) The identifying information 36 may be used in conjunction with the rules 32 and 34 to determine the most applicable assets to be provided to the user 12 on the website 14.

FIG. 2 illustrates an example of presenting a list of applicable assets 26 to the user 12 via the website 14. As discussed above, the user 12 may access a website 14 of the publisher/web host 16. The website 14 may provide the web request 28 to the applicability service 24, which may be running on a server provided by the asset provider 22. In the example of FIG. 2, the web request 28 may include identifying information 36 specifying that the user 12 is employed by Employer Y. Further, the web request may include other information 62 relating to the request for applicable assets. For example, the web request 28 may include a number of assets to return in the asset response 30. In the example of FIG. 2, the web request 28 includes a request for 3 assets to be returned.

As discussed above, the asset provider 22 may determine applicable assets based upon the applicability service 24. The applicability service 24 may include an asset reference library 64 that maintains reference information for assets 66 of one or more vendors 68. In the example depicted in FIG. 2, Vendor 1 has provided a rule 70 stating that asset 4 should only be provided when the employer of user 12 is X. Further, Vendor 2 has provided a vendor rule 72 that asset 2 should only be provided if the employer=Y. Additionally, the applicability service 24 may include applicability rules 34 that are not vendor requirements, but still affect the applicability of assets for a user 12. For example, the system 60 of FIG. 2 may include a priority applicability rule, dictating that one asset (e.g., asset 3) is to be given more applicable priority (e.g., suggested as applicable more often) for all users 12 when there are no conflicting rules.

Assuming that no other conflicting rules are provided to the applicability service 24, the applicability service 24, based on the request for 3 assets, determine the top three applicable assets in the asset reference library 64 (e.g., of assets 1-6). In many instances, an asset provider may only receive revenues when a user 12 accesses assets of a vendor 68 according to the vendors' rules 32. Accordingly, applicable assets may be assets that are most likely to have a high yield, or high likelihood of generating revenues for the asset provider 22. For example, the asset provider 22 may not receive revenues when an employee of Y accesses asset 4, because vendor rule 70. Accordingly, the more restrictive a revenue producing asset becomes based upon a rule, the higher desirability the asset provider may have in providing that asset when a user 12 meets the criteria. For example, if vendor rule 72 restricts revenue for asset 2 to users 12 that work for Employer Y, the asset provider 22 may specifically chose to provide asset 2 when an employee of Employer Y is to receive an applicable asset list. Further, the asset provider 22 may desire not to provide assets that are unlikely to result in the user 12 accessing the asset (e.g., the asset will be unpopular with the user 12) or that will not result in revenues (e.g., because of a rule, such as rule 70 when it is applied to the identifying information 36). Accordingly, in the example of FIG. 2, asset 4 may not be provided to the user 12.

Because the applicability service has been requested to provide 3 assets, and only asset 2 has been proactively selected and asset 4 has been proactively removed for the applicable assets, the applicability rules 34 may be employed to find two other assets within assets 1, 3, 5, and 6 that should be added to the applicable asset list 26. As mentioned above, asset 3 may gain preference based upon an applicable priority rule, and thus may be added to the list 26. When no other applicability rules 34 or vendor rules 32 correspond to the identification information 36 and/or the remaining assets 66, the applicability service may select additional assets using a back fill process. The back fill process will ensure that the proper number of assets will be returned, based upon the number requested, by selecting additional assets, regardless of applicability to be added to the applicability list 26. The back fill process may be based upon random draw, balanced acquisition (e.g., round-robin asset selection sequencing), or other approach. For example, in a balanced acquisition approach, each remaining asset 66 may be selected once before being selected again during the back fill process.

Once the applicability service 24 has determined the proper number of assets to provide (e.g., 3 in this example), the applicability service 24 may provide a list 26 of the selected assets 74 to the user 12 on the website 14. By presenting the user 12 with more applicable assets 74, the revenues of the asset provider 22 may potentially increase, because there may be an increased chance of user 12 interacting with revenue generating assets 66.

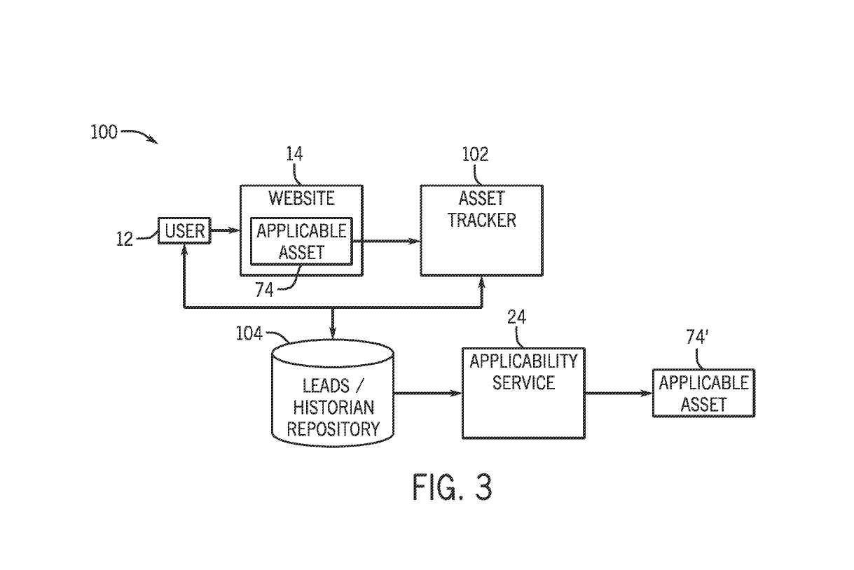

In some embodiments, the historical information, such as success and failure rates of suggested assets may be tracked and used in determining future applicable assets. FIG. 3 is a block diagram illustrating a system 100 that stores and uses historical information to enhance determination of applicable assets. Similar to FIGS. 1 and 2, a user 12 accesses a website 14 where applicable assets 74 are provided to the user 12. In this embodiment, an asset tracker 102 may track whether the user 12 interacts with the suggested assets 74 and store the tracking information in a historian or other database repository 104. The database repository 104 may include information such as impression information. An impression is a served asset or advertisement. Historical impression information may include the number of times an asset or ad has been presented to a user or all of the users in the system. Further, the database repository 104 may include lead information, such as a number of qualified leads as well as form completion information, such as the number of supplemental data forms completed to reach an asset. For example, a lead may be a recorded interaction with an asset, such as a user downloading an asset. The supplemental data form completion information may relate to information relating to a user completing a survey or other supplemental questions in order to interact with an asset (e.g., download the asset). The applicability service 24 may access the tracking information in the database repository 104 and use the tracking information to determine enhanced applicable assets 74′ for subsequent requests.

As discussed above, the yield may determine applicability of the assets. Many factors, including historical factors, may go in to calculating an asset's projected yield. For example, an asset's yield may depend on a Lead Through Rate (LTR), a Form Through Rate (FTR), a Form Completion Rate (FCR), Predicted Applicability (PA), and/or Relevancy (R). For example, in one embodiment, the applicability service 24 may calculate the yield of a particular asset as:

Yield=(LTR+FTR*FCR*Applicability)*Bid*R

where:

$$LTR = \frac{Yieldable Qualified Leads}{Ad Impressions}$$

$$FTR = \frac{Yieldable Form Impressions}{Ad Impressions}$$

$$FCR = \frac{All Downloads}{All Form Impressions}$$

R=1 when choice is based upon a campaign category or
R=A contextual multiplier based on a user query, web page content, or other asset downloaded by the user

As new assets are added to the asset reference library 64, no historical information may be stored for the new assets in the database repository 104. Accordingly, certain default values may be used until sufficient historical data is available for the new asset. For example, since the LTR is a counter for the # of yieldable qualified leads divided by the # of yieldable impressions, the default value of LTR may be zero. Because the FTR may be more generalized based upon a type of publisher and/or vertical grouping, the default for FTR may be an average of the FTR of assets with historical information from a common publisher and/or a common vertical grouping. The FCR may default to an average of the FCR for assets with historical information from a common publisher. For Applicability, the default may be calculated based upon a percentage of users who have filled out and submitted a form and met campaign filters, regardless of publisher. Applicability may be calculated once per day and may be guaranteed to be greater than zero, such that an asset will not be excluded merely based upon applicability.

Many other mechanisms may be used to maximize revenues generated by users 12 accessing the assets. For example, in addition to the applicability service 24 selecting assets based upon a user's profile and selecting assets with higher yields, as discussed above, the applicability service 24 may rotate assets to keep the assets fresh to user 12. For example, when the same assets are provided each time the user 12 accesses the website 14, the asset list 74 may become “stale” to the user 12. In other words, the asset list 74 may become less interesting to the user 12. Accordingly, the applicability service 24 may cycle “fresh” asset listings through to the user 12 on a periodic basis. Further, the applicability service 24 may attempt to deliver non-empty asset lists 24 at all times, even when there are no assets that meet the user 12's profile or is likely to generate revenue. Providing non-empty asset lists may provide more awareness of preferences of the user 12 or other information regarding the assets in the non-empty list. For example, as discussed above, an asset tracker 102 may track historical information about the user 12 and/or the assets in the asset list 74. Accordingly, information about the type of users 12 accessing an asset previously believed to be non-applicable to a particular user 12's profile may be observed and noted. This historical data may help to effectively add additional audience profiles for a particular asset as well as identify further interests associated with a particular user 12's profile.

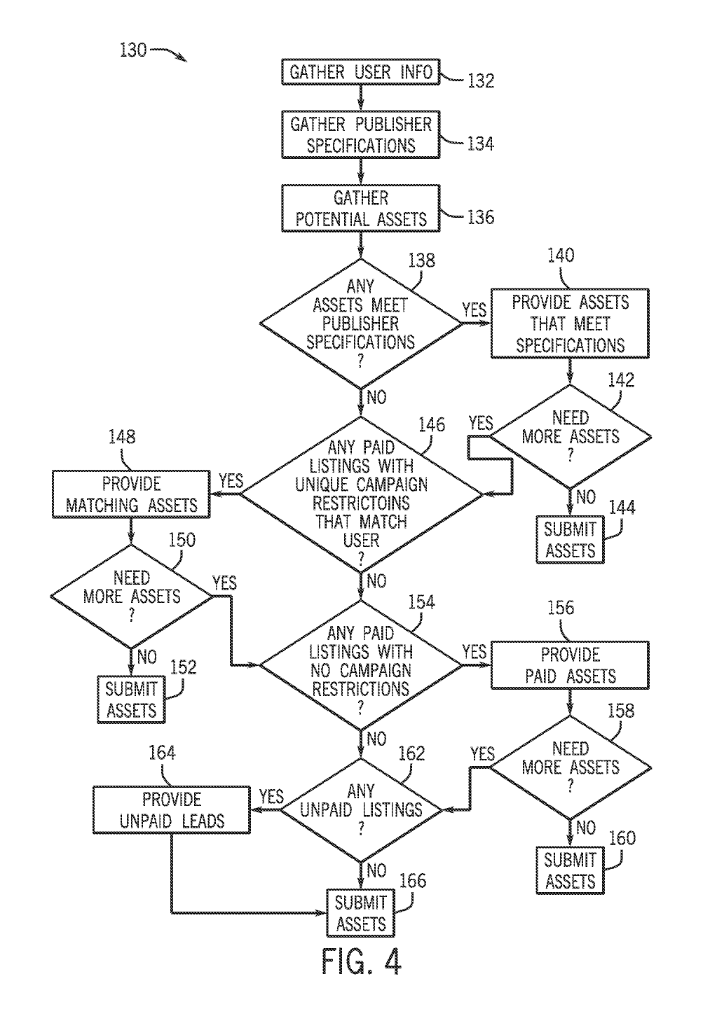

Turning now to a more focused discussion of the asset selection process, FIG. 4 is a flow diagram illustrating a process 130 for selecting applicable assets from an available asset reference library, based on revenue attributes of the assets in the asset reference library. To more effectively select revenue generating assets, the applicability service or other computer-implemented function may gather user information, such as an identity of the user, the user's interests, the user's location, the user's employment information, etc. (block 132). Information about specific publisher specifications, such as assets that have particular profiles of interest for lead generation, etc. may also be gathered (block 134). The list of potential assets is also gathered from the asset reference library (block 136). The process 130 may prioritize any publisher specifications as being of top-most importance when selecting the applicable assets. For example, when a publisher desires that their own assets or assets from companies that they sell product for be favored, such assets will be provided first. This helps to ensure that the publisher may have confidence in their own revenue generating abilities, thus providing increased adoption by the publisher of the applicability service. Accordingly, there is a significant importance that the asset provider look at any specifications provided by the publisher. Accordingly, the process 130 may determine whether any of the potential assets should be supplied (or not supplied) based upon publisher specifications (decision block 138). If there are specific assets that may be provided based upon the publisher specifications, the assets are provided (e.g., added) to a list of applicable assets to be sent to the user (block 140). The process 130 then determines whether additional assets should be supplied over and above the assets provided in block 140 (decision block 142) (e.g., based upon a number requested by a web request). If no additional assets are needed, the asset list is submitted (e.g., via a web response) to the website or other entity requesting applicable assets for a user (block 144).

If additional assets are needed or there were not any assets to be provided based upon the publisher specifications, the process 130 may determine whether there are any paid listings with unique campaign restrictions that match a user profile (decision block 146). For example, a campaign may provide revenues for a specific asset accessed by a user profile that includes specific user profile filters (e.g., a user who is over 30 years old and makes a salary of over $100,000 per year). Because these campaigns with unique restrictions are not always met by every user profile, it may be beneficial to pick assets that apply when these unique criteria are met. This may help to increase revenues for the asset provider, by actively selecting campaigns that may not be easy to fulfill. Accordingly, if there are assets that may be provided based upon a user profile matching unique criteria for a paid listing, the assets may be provided in the asset list (block 148). The process 130 may determine if additional assets are needed (block 150). If no additional assets are needed, the asset list may then be submitted (block 152).

If additional assets are needed or no paid listings with unique campaign restrictions match the user profile, the process 130 may determine whether there are any paid listings without unique campaign restrictions (decision block 154). If there are paid listings without unique campaign restrictions, the assets are provided to the asset list (block 156). The process 130 may then determine whether additional assets are needed (block 158). If no additional assets are needed, the asset list is submitted (block 160).

If additional assets are needed or no paid listings without unique restrictions are available, the process 130 determines if there are any unpaid listings (decision block 162). If there are unpaid listings, the assets associated with the listings are provided to the asset list (block 164). If there are no unpaid listings, no additional assets are added to the asset list. Lastly, the asset list is submitted (block 166).

In some instances other features may be added to determine a priority of applicable assets. For example the applicability service may exclude previously accessed assets from future listings, as the user has already accessed the asset. Further, a campaign date may be associated with certain assets, where the campaign date defines date limitations for receiving revenues from a user accessing the asset. Accordingly, the applicability service may exclude assets where the campaign dates have been breached. Additionally, the revenues may be directly impacted by an advertiser's ability and/or willingness to pay. Accordingly, for advertisers with little to no budget, the applicability service may limit the frequency that the advertiser's assets will be returned in the asset list. Further, a publisher may set a minimum CPL level. When the campaign has a lower CPL than the publisher's minimum set value, the campaign may be excluded. The publisher may also request that particular assets from a certain vendor or advertiser be blocked by providing a block list. Any and all assets provided by a vendor or advertiser on the blocked list will not be provided for a particular publisher's webpage when the publisher specifically blocks the vendor or advertiser. Also, a publisher may reserve part of an advertiser's balance advance, such that such balance may be used for listing inventory served in email blasts.

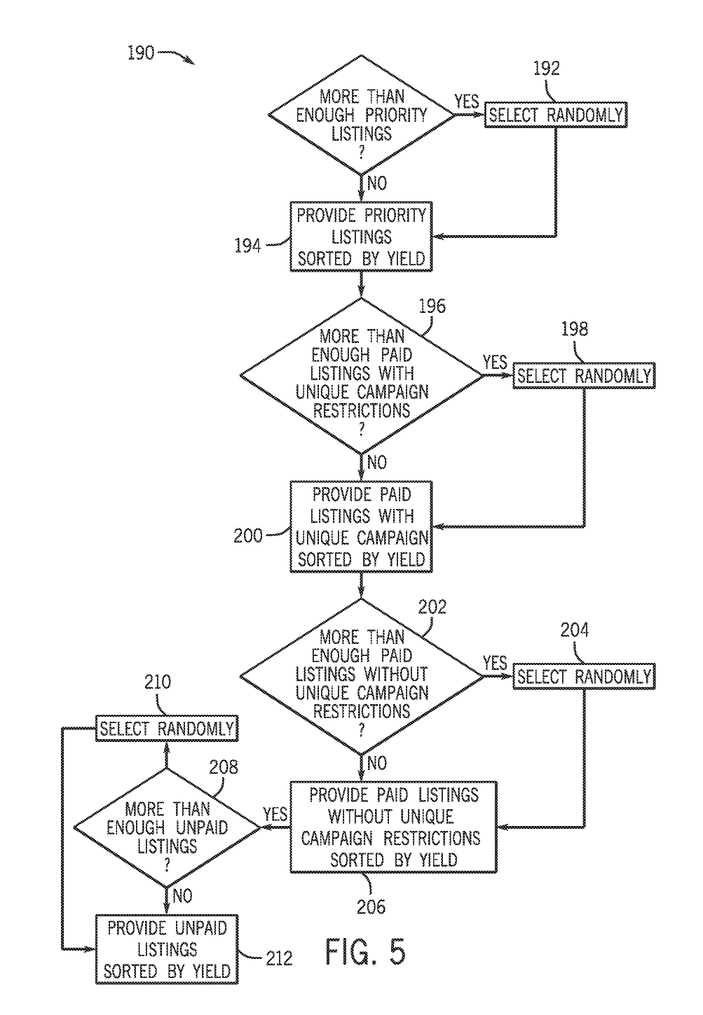

Having now discussed a process for selecting assets that are applicable, FIG. 5 is a flow diagram illustrating a process 190 for selecting and/or sorting an asset list to enhance revenues. Further, in the embodiment of FIG. 5, the assets may be selected using a weighted random selection algorithm. In process 190, assets that are within a particular class of asset (e.g., priority assets based upon publisher specifications, paid listings with unique campaign restrictions, paid listings without unique campaign restrictions, and unpaid listings) are equally selectable within each particular class. However, it may be beneficial to select higher yielding assets more frequently. Accordingly, when there are more than enough assets in a particular class of assets, the assets are provided in a weighted random sort order. The weighted random sort order may attempt to attribute a higher frequency of selection to higher yielding assets to offset the likelihood that lower yielding assets will be selected over higher yielding assets. For example, one weighted random selection algorithm might be implemented as follows:

weightSum=0.//Accumulating sum of weights

for (asset i to n) {
weight=yield of first asset;
weight*=1+(weight/sum of all asset yields)*remainingCount
weight Sum+=weight;
accumulatedWeights[i]=weightSum;

The process 190 determines if there are more than enough priority assets to satisfy the number of applicable assets requested (decision block 192). If there are more than enough priority assets, the assets are selected randomly (e.g., according to the weighted random selection algorithm discussed above) (block 192). Next, the assets (either all of the priority assets when there are not enough to satisfy the request or the randomly selected subset of priority assets) are sorted by yield and provided to the asset list (block 194). If there were not enough priority assets to satisfy the request, the process 190 determines if there are more than enough paid assets with unique campaign restrictions that can satisfy the request (block 196). If there are more than enough, the assets are selected from this class randomly (e.g., according to the weighted random selection algorithm discussed above) (block 198). Next, the assets (either all of the paid assets with unique campaign restriction assets when there are not enough to satisfy the request or the randomly selected subset of paid assets) are sorted by yield and provided to the asset list (block 200). If additional assets are still needed to satisfy the request, the process 190 determines whether there are more than enough paid assets without unique campaign restrictions to satisfy the request (block 202). If there are, the assets are selected randomly from among this class (block 204). The assets (either all of the paid assets without unique campaign restriction assets when there are not enough to satisfy the request or the randomly selected assets) are sorted by yield and provided to the asset list (block 206). If additional assets are still needed to satisfy the request, the process 190 determines if there more than enough unpaid assets to satisfy the request (decision block 208). If there are, the assets are selected randomly (e.g., according to the weighted random selection algorithm discussed above) (block 210). The assets (either all of the unpaid assets when there are not enough to satisfy the request or the randomly selected subset of assets) are sorted by yield and provided to the asset list (block 212).

The various embodiments described herein provide a system and method for determining applicable assets for a user of website based upon revenue generating characteristics and rules. The applicability service may act to increase revenues by pinpointing assets that are more interesting to a user, will provide an increased likelihood of accessing the asset, and/or that fall within vendor specifications or unique revenue-generating criteria. The assets may be prioritized based upon revenue-generating classes and/or sorted based upon their revenue-generating abilities.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, an asset tracker and applicability service may either be executed independently, on separate hardware or may be executed on a common computer. Similarly, the various features described, as well as other known equivalents for each feature, may be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for determining a list of revenue-generating electronically transmissible documents relating to a user, comprising:
gathering identifying information relating to the user, wherein the user is accessing a website that is requesting the list of revenue-generating electronically transmissible documents;
gathering potential electronically transmissible documents from a list of available electronically transmissible documents;
determining the list of revenue-generating electronically transmissible documents from the potential electronically transmissible documents based upon at least the identifying information relating to the user.

2. The method of claim 1, comprising:
gathering publisher specification that limits at least one electronically transmissible document of the potential electronically transmissible documents that may displayed on the website; and
determining the list of revenue-generating electronically transmissible documents based at least in part upon the publisher specification.

3. The method of claim 2, comprising:
determining if any of the potential electronically transmissible documents meet the publisher specification; wherein determining the list of revenue-generating electronically transmissible documents comprises adding an electronically transmissible document to the list of revenue-generating electronically transmissible documents only when an electronically transmissible document in the potential electronically transmissible documents meets the publisher specification.

4. The method of claim 1, comprising:
determining one or more electronically transmissible documents from the potential electronically transmissible documents that are associated with an offer to provide revenue when the electronically transmissible document is accessed by any user; wherein determining the list of revenue-generating electronically transmissible documents comprises adding an electronically transmissible document to the list of revenue-generating electronically transmissible documents only when the electronically transmissible document is associated with the offer to provide revenue.

5. The method of claim 1, comprising:
determining one or more electronically transmissible documents from the potential electronically transmissible documents that are associated with an offer to provide revenue when the electronically transmissible document is accessed by any user and certain criteria are met by the user's identifying information;
wherein determining the list of revenue-generating electronically transmissible documents comprises adding an electronically transmissible document to the list of revenue-generating electronically transmissible documents only when the electronically transmissible document is associated with the offer to provide revenue and the certain criteria is met by the user's identifying information.

6. The method of claim 1, comprising:
gathering a publisher specification that limits at least one electronically transmissible document of the potential electronically transmissible documents that may displayed on the website; and
determining a number of electronically transmissible documents that should be provided in the list of revenue-generating electronically transmissible documents;
wherein determining the list of revenue-generating electronically transmissible documents comprises:
determining electronically transmissible documents that meet the publisher specification;
adding the electronically transmissible documents that meet the publisher specification to the list of revenue-generating electronically transmissible documents; and
adding additional electronically transmissible documents from the potential electronically transmissible documents when there are fewer electronically transmissible documents that meet the publisher specification than the number of electronically transmissible documents that should be provided in the list of revenue-generating electronically transmissible documents.

7. The method of claim 6, wherein adding the additional electronically transmissible documents comprises:
determining if any electronically transmissible documents are associated with an offer to provide revenue when the electronically transmissible document is accessed by the user; and
adding the electronically transmissible documents associated with the offer to provide revenue to the list of revenue-generating electronically transmissible documents; and
if additional electronically transmissible documents are still needed to meet the number of electronically transmissible documents that should be provided after adding the electronically transmissible documents associated with the offer to provide revenue, adding electronically transmissible documents that are not associated with an offer to provide revenue when the electronically transmissible document is accessed by the user.

8. The method of claim 6, comprising:
determining electronically transmissible documents that have unique restrictions associated with the offer to provide revenue for accessing certain electronically transmissible documents;
wherein adding the electronically transmissible documents associated with the offer to provide revenue to the list of revenue-generating electronically transmissible documents, comprises:
first adding electronically transmissible documents that have the unique restrictions associated with the offer to provide revenue when the unique restrictions are met by the user's identifying information; and
adding electronically transmissible documents that do not have the unique restrictions associated with the offer to provide revenue when additional electronically transmissible documents are needed to meet the number of electronically transmissible documents that should be provided.

9. The method of claim 1, wherein the potential electronically transmissible documents are divided into revenue-generating classes of different priorities, and electronically transmissible documents are selected from a top priority class first and a lowest priority class last; wherein a last portion the electronically transmissible documents are selected from a last used class randomly when there are more than enough electronically transmissible documents in the last used class to fulfill a remaining number of needed documents to satisfy a number of requested electronically transmissible documents.

10. The method of claim 9, wherein when the electronically transmissible documents are selected from the classes randomly, they are selected according to a weighted random selection algorithm that creates a bias towards selecting electronically transmissible documents with a higher yield potential.

11. The method of claim 9, wherein the potential electronically transmissible documents are divided into revenue-generating classes, comprising:
a first class of priority listings defined by publisher specifications;
a second class of paid listings with unique restrictions that require a match to a user's identifying information;
a third class of paid listings without unique restrictions; and
a forth class of unpaid listings;
wherein the electronically transmissible documents are selected from the first class first, the second class if there are not enough electronically transmissible documents in the first class, the third class if there are not enough electronically transmissible documents in the first and second classes, and the fourth class if there are not enough electronically transmissible documents in the first, second, and third classes.

12. A non-transitory, computer-readable medium, comprising computer-readable instructions to:
accept a web-request from a website, the web-request configured to provide identifying information of a user of the website and request a number of electronically transmissible documents for the website that are applicable to the user;
generate a list of electronically transmissible documents that is applicable to the user based upon the identifying information; wherein the list of electronically transmissible documents comprises a number of electronically transmissible documents equal to the requested number of electronically transmissible documents when enough electronically transmissible documents are available, and wherein the electronically transmissible documents provided in the list of electronically transmissible documents comprise electronically transmissible documents that are most likely to produce revenue for an electronically transmissible document provider suggesting the electronically transmissible documents.

13. The non-transitory, computer-readable medium of claim 12, comprising computer-readable instructions to:
determine the electronically transmissible documents most likely to produce revenue according to a formula:
Yield=(LTR+FTR*FCR*Applicability*R)*Bid
where:
$$LTR = \frac{Yieldable Qualified Leads}{Ad Impressions}$$
$$FTR = \frac{Yieldable Form Impressions}{Ad Impressions}$$
$$FCR = \frac{All Downloads}{All Form Impressions}$$
R=1 when choice is based upon a campaign category or
R=A contextual multiplier based on a user query, web page content, or other asset downloaded by the user

14. The non-transitory, computer-readable medium of claim 13, comprising computer-readable instructions to sort the list of electronically transmissible documents according to the formula, wherein the highest yield electronically transmissible documents are sorted first in the list of electronically transmissible documents.

15. The non-transitory, computer-readable medium of claim 12, comprising machine-readable instructions to:
divide available electronically transmissible documents into four priority classes, the first priority class based upon publisher specifications being met, the second priority class based upon paid listings with unique restrictions that match a user's identity information, the third priority class based upon paid listings without unique restrictions, and the forth priority class based upon unpaid listings;
select electronically transmissible documents in a top down approach from the first priority class to the fourth priority class;
select all electronically transmissible documents in a given class when there are not enough electronically transmissible documents to fulfill the requested number of electronically transmissible documents counting any previously selected electronically transmissible documents from another priority class; and
randomly select a portion of electronically transmissible documents in the given class when there are more than enough electronically transmissible documents available with the priority class to fulfill the requested number of electronically transmissible documents counting any previously selected electronically transmissible documents from another priority class.

16. The non-transitory, computer-readable medium of claim 15, where randomly selecting a portion of electronically transmissible documents in the given class comprises randomly selecting electronically transmissible documents using a weighting mechanism that biases the random selection towards selecting higher yielding electronically transmissible documents.

17. The non-transitory, computer-readable medium of claim 15, comprising machine-readable instructions to:
sort the list of electronically transmissible documents from highest to lowest yield using a yield calculation formula that takes into account: lead through rate, form through rate, form completion rate, and relevancy.

18. A system, comprising:
an electronically transmissible document provider server hosting an electronically transmissible document applicability service configured to:
receive web requests from a website hosted by a publisher's web server, the web request comprising a number of applicable electronically transmissible documents for a user of the website and identifying information for a user of the website;
compile an electronically transmissible document reference library comprising a listing of available electronically transmissible documents provided by one or more vendors via a vendor server or storage device;
predict a subset of electronically transmissible documents that are likely to result in the highest revenues for the electronically transmissible document provider; and
provide the subset of electronically transmissible documents to the website user via an electronically transmissible document response comprising the subset of electronically transmissible documents;
wherein the applicability server is configured to determine the subset of electronically transmissible documents based at least upon: the number of applicable electronically transmissible documents in the web request, a set of rules or specifications provided by the one or more vendor servers, and a set of applicability rules relating to anticipated yields of each of the electronically transmissible documents in the electronically transmissible document reference library based upon the user's identifying information.

19. The system of claim 18, comprising an electronically transmissible document tracking service that monitors and stores monitoring information relating to a user's interaction with an electronically transmissible document; wherein the applicability service is configured to use the monitoring information to better predict the subset of electronically transmissible documents that are likely to result in the highest revenues for the electronically transmissible document provider.

20. The system of claim 18, wherein the identifying information for the user comprises: a media access control address, an Internet Protocol address, or other information that identifies a computer system of the user, wherein the other information comprises: browser information of the computer system, operating system information of the computer system, installed software of the computer system, behavioral history discerned from the computer system, a geographic location of the computer system, or any combination thereof;
and characteristic information of the user, comprises: employment information, whether the user is male or female, the age of the user, the marital status of the user, or any combination thereof.
